(19) United States
(12) Patent Application Publication
(10) Pub. No.: US 2017/0149561 A1
(43) Pub. Date: May 25, 2017

(54) METHOD AND SYSTEM FOR IDENTIFYING MANIPULATION OF DATA RECORDS

(71) Applicant: Siemens Aktiengesellschaft, München (DE)

(72) Inventors: Jens-Uwe Bußer, Neubiberg (DE); Jorge Cuellar, Baierbrunn (DE); Michael Munzert, Gräfelfing (DE); Heiko Patzlaff, München (DE); Jan Stijohann, München (DE)

(21) Appl. No.: 15/322,351

(22) PCT Filed: May 8, 2015
(86) PCT No.: PCT/EP2015/060209

§ 371 Date: Dec. 27, 2016

(30) Foreign Application Priority Data
Jul. 10, 2014 (DE) 10 2014 213 454.4

(51) Int. Cl. H04L 9/06; H04L 9/08

(52) U.S. Cl. CPC H04L 9/0643; H04L 9/0861; G06F 21/64

(57) ABSTRACT

A method for identifying manipulation of data records in a system including a computation apparatus and an external security apparatus, wherein the data records are stored in the computation apparatus, having the method steps of: allocation of a secret to a computation apparatus, generation of a first cryptographic key by a one-way function on the basis of the secret, storage of the secret on a security apparatus that is different from the computation apparatus, use of the first cryptographic key for the purpose of protecting a first data record, and generation of a respective next cryptographic key by the same one-way function on the basis of the respectively preceding cryptographic key for the purpose of protecting a next data record on the computation apparatus and simultaneous erasure or overwriting of the respectively preceding cryptographic key.

### CROSS-REFERENCE TO RELATED APPLICATIONS

This application claims priority to PCT Application No. PCT/EP2015/060209, having a filing date of May 8, 2015, based off of German application No. DE 102014213454.4 having a filing date of Jul. 10, 2014, the entire contents of which are hereby incorporated by reference.

### FIELD OF TECHNOLOGY

The following relates to a method and a system for identifying manipulation of data records in a system having at least one computation apparatus and an external security apparatus, wherein the data records are stored in the computation apparatus.

### BACKGROUND

For the purpose of monitoring and identifying malicious intrusions into a computation apparatus, various security-relevant data records, which are generated by application programs or the operating system, for example, are stored in a file system of the operating system. Examples of security-relevant data records of this kind are log data that indicate failed login attempts by users on the computation apparatus or changes to system-relevant parameters, for example. These security-relevant data records are stored in the computation apparatus and protected by rights-based access protection on the operating system. If there is a suspicion of manipulation of the computation device, then these data records can be used for later forensic analysis of the computation apparatus.

When a computation apparatus is successfully attacked by an attacker, said attacker can usually also obtain the necessary access rights to erase or alter said security-relevant data records in order to disguise the attack afterwards. Thus, the corresponding traces of the attack that have been recorded in the security-relevant data are obliterated and an illegal access to the computation apparatus therefore remains undetected. Furthermore, it is then no longer possible to identify how the computation apparatus has been altered or attacked and to analyze what weaknesses have been exploited for that purpose.

### SUMMARY

An aspect relates to providing a way of identifying, even afterwards, whether and if need be what security-relevant data records have been manipulated and hence of establishing that an attack on the computation apparatus took place.

Besides automatically generated log data, the method according to embodiments of the invention can also be used to protect other, gradually newly arising data records—subsequently referred to as “security-relevant data records”—against later undetected alterations.

The method according to embodiments of the invention for identifying manipulation of security-relevant data records in a system that comprises a computation apparatus, in which security-relevant data records are stored, and an external security apparatus involves, as a first method step, a secret being assigned to a computation apparatus. The next method step is to generate a first cryptographic key using a one-way function on the basis of the secret and subsequently to store the secret on a security apparatus that is different than the computation apparatus, and to ensure that the secret is not accessible in the computation apparatus. The next method step involves the first cryptographic key being used to safeguard the first security-relevant data record. Thereafter, a respective next cryptographic key is generated using the same one-way function on the basis of the respective preceding cryptographic key in order to safeguard the next security-relevant data record on the computation apparatus, and the respective preceding cryptographic key is simultaneously erased or overwritten.

Hence, only the cryptographic key that is needed for safeguarding the next security-relevant data record is ever present in the computation apparatus. On account of the construction of the cryptographic key using a one-way function, it is not possible to infer the preceding keys from the cryptographic key currently available. Hence, the preceding data records cannot be modified undetected. Although an attacker can use the single available cryptographic key to tamper with the next security data records, he cannot change the already safeguarded stored security data records that have already been produced and stored before the time of system acquisition and taking note of the current key. When the attacker erases safeguarded data records, this is likewise detected.

In an advantageous variant of the method according to embodiments of the invention, the secret is generated in the computation apparatus and transmitted to the security apparatus in a secure manner.

By way of example, the secret is formed by means of a pseudorandom number generator from a “seed”, generated externally and different for each computation apparatus, that is loaded during initial configuration, or—if available—is generated by means of an integrated true physical random number generator. For the purpose of secure transmission to the security apparatus, the secret is encrypted in the computation apparatus, for example using a public asymmetric key of the security apparatus, and transmitted to the latter. Alternatively, it is also possible to use any other secure transmission, such as an existing IPSEC or TLS connection, for example.

In an advantageous variant, the secret is generated in the security apparatus.

This has the advantage that a high quality, cryptographically secure random number generator needs to be available only in a central component such as a security apparatus. Furthermore, central management of the secrets is possible in a simple manner.

In this case, the secret needs to be transmitted from the security apparatus to the computation apparatus using a secure connection. This may be an existing IPSEC or TLS connection, for example. Manual distribution by means of a mobile data memory such as a USB memory stick or manual input by an engineer is likewise possible in principle, but more complex.

In the case of an industrial installation having a large number of computation apparatuses with previously scheduled configuration of the individual computation apparatuses, the security apparatus can load the secret together with the configuration even before the individual computation apparatuses are put into operation. During configuration, there is in most cases still no access to an external network, and hence secure transmission exists. The security apparatus in an industrial automation installation may particularly be the engineering station.

In an advantageous embodiment, the secret and the first cryptographic key are generated on the security apparatus and only the first cryptographic key is subsequently transmitted to the computation apparatus.

This has the great advantage that the secret does not leave the security apparatus at any time and is not transported via an external connection. This reduces the possibility of manipulation or interception of the secret significantly. It is also possible for the secret to be generated directly as the first cryptographic key and for only the first cryptographic key to be subsequently transmitted to the computation apparatus. When the first cryptographic key is derived, the first application of the one-way function is then dispensed with.

In an advantageous embodiment of the method according to the invention, the safeguarding of the security-relevant data record is performed by encrypting the data record using the cryptographic key.

This has the advantage that an unauthorized party cannot read the content of the data record in plain text, since it is available exclusively in encrypted form and the matching cryptographic key is no longer available on the computation apparatus.

In an advantageous embodiment, the safeguarding of the security-relevant data record is performed by assigning a message authentication code generated using the cryptographic key to the security-relevant data record.

A message authentication code is usually generated by a hash function from the underlying data, in this case the security-relevant data record and the assigned cryptographic key. This method makes it possible to identify whether the security-relevant data record has been modified, since if the secret is known then any of the cryptographic keys used can be generated again univocally in terms of value and order. This means that it is possible to check whether a message authentication code that is computed from the stored security-relevant data record and a cryptographic key regenerated from the secret matches the message authentication code stored with the data record. If this is not the case, then the data record has been altered in the interim.

In a variant of the method according to embodiments of the invention, the secret comprises an answer character string that has been provided as an answer to a security question.

The integration of an additional answer character string allows the secret to be demarcated from the secrets of other computation apparatuses, particularly when configuration of different secrets is difficult to perform. This hampers inference of the secret of another computation apparatus from the secret of a computation apparatus.

In an advantageous variant, a new secret is assigned to the computation apparatus on the basis of a prescribed event, and the method steps already described are performed using the new secret.

In a further variant, a new secret is assigned to the computation apparatus after a request for the security-relevant data records, and the method steps described above are performed using the new secret.

The two variants described have the advantage that the number of log entries that are generated with the secret is limited. This shortens the time for emulating the cryptographic keys used, particularly the most recently formed cryptographic keys.

The system according to embodiments of the invention for identifying manipulation of security-relevant data records comprises a computation apparatus and an external security apparatus that is remote from the computation apparatus, wherein the computation apparatus is designed to store security-relevant data records, to use a first cryptographic key that has been generated by a one-way function on the basis of a secret for the purpose of safeguarding the first security-relevant data record and to ensure that the secret is not accessible in the computation apparatus, and to generate a respective next cryptographic key using the same one-way function on the basis of the respective preceding cryptographic key for the purpose of safeguarding a next security-relevant data record and to simultaneously erase or overwrite the respective preceding cryptographic key. The security apparatus is designed to store the secret permanently.

Such a system has the advantage that manipulation of the system, particularly of the computation apparatus, is still identified afterwards, since missing security-relevant data records or modified data records are identified. This results from the fact that only a single cryptographic key is present in the computation apparatus itself and this cryptographic key cannot be used for the preceding security-relevant data records for safeguarding purposes. Therefore, an attacker can neither decrypt nor modify and reencrypt an already existing data record using this cryptographic key. If individual data records are missing between the existing, unmanipulated data records, then the number of missing data records can be ascertained from the number of successive cryptographic keys not used. Furthermore, it is possible to ascertain an earliest possible time of successful intrusion from when the data records have been manipulated, since usually a time stamp is generated with each data record and hence with each cryptographic key used, and hence the time of a manipulation can be ascertained from the first missing cryptographic key.

In an advantageous embodiment, the computation apparatus is designed to generate the secret and to transmit it to the security apparatus.

Since a secret has to be generated only once or at long intervals of time, even a computation apparatus of simple design can generate a sufficiently random secret. The computation apparatus and hence also the time of generation of the secret are very flexible and, by way of example, independent of the continual availability of a communication link to a superordinate unit, for example the security apparatus.

In a further advantageous embodiment, the security apparatus is designed to generate the secret and to transmit it to the computation apparatus.

The security apparatus can therefore be used to perform central distribution and central management of the secrets.

In an advantageous embodiment, the security apparatus is designed to also generate the first cryptographic key and subsequently to transmit only this first cryptographic key to the computation apparatus.

This has the advantage that the first application of the one-way function is dispensed with.

In a further advantageous embodiment, the computation apparatus is designed to perform the safeguarding of the security-relevant data record by encrypting the data record using the cryptographic key or by assigning a message authentication code generated using the cryptographic key to the security-relevant data record.

### BRIEF DESCRIPTION

Some of the embodiments will be described in detail, with reference to the following figures, wherein like designations denote like members, wherein:

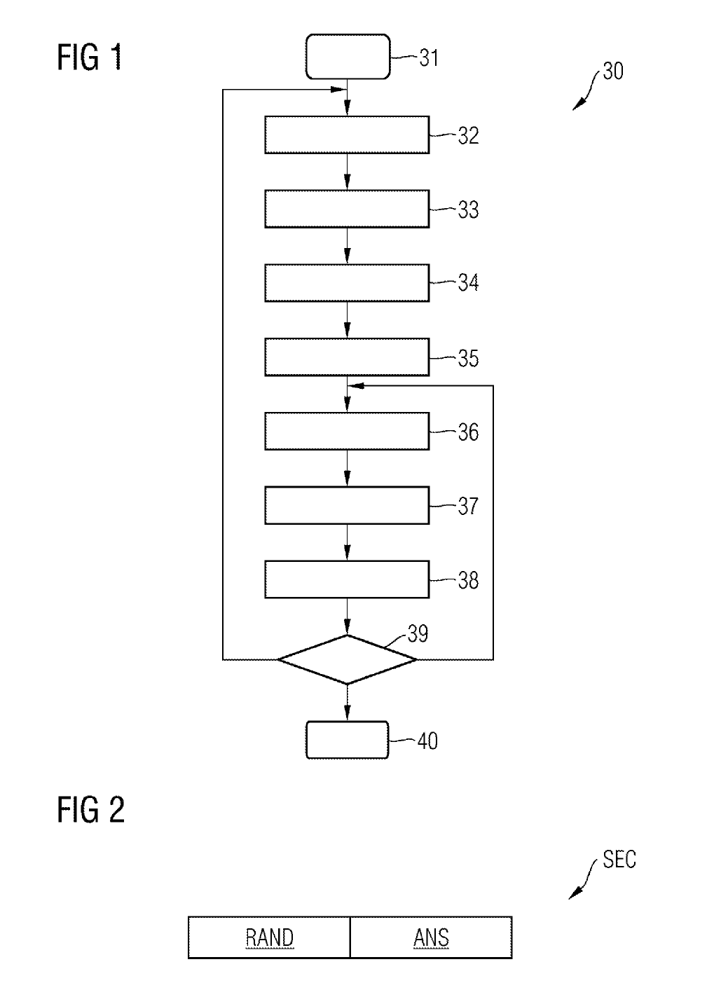

FIG. 1 shows an exemplary embodiment of the method in the form of a flowchart;

FIG. 2 shows an exemplary form of a secret in a schematic representation;

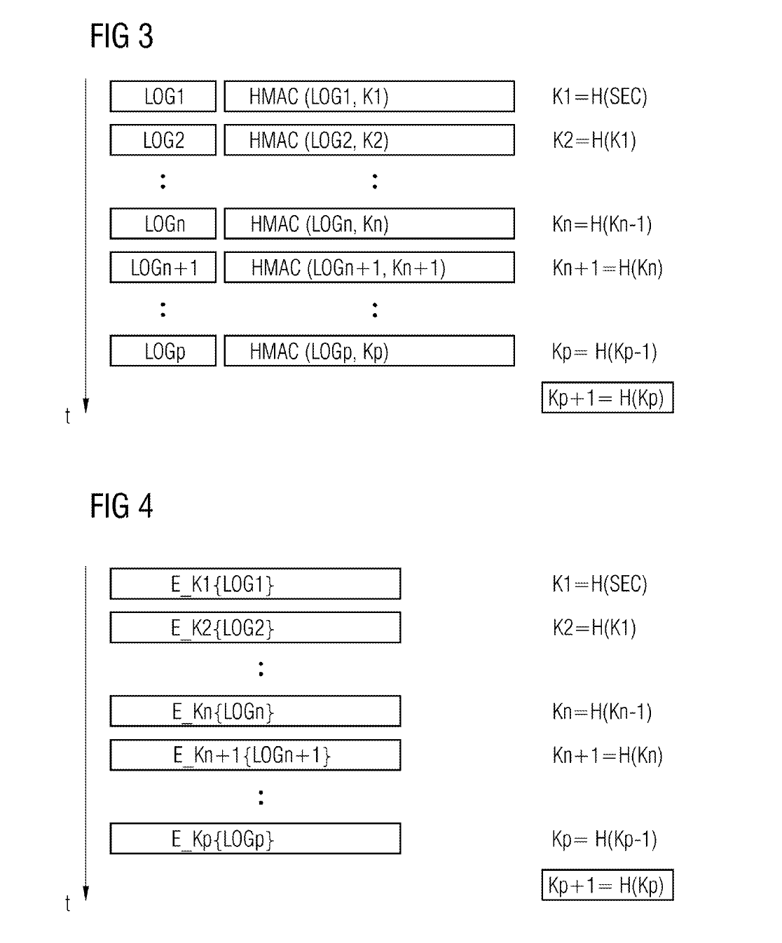

FIG. 3 shows exemplary security-relevant data records safeguarded by means of appended message authentication code in a schematic representation;

FIG. 4 shows exemplary data records safeguarded by cryptographic encryption in a schematic representation;

FIG. 5 shows a first exemplary embodiment of a system in a schematic representation; and

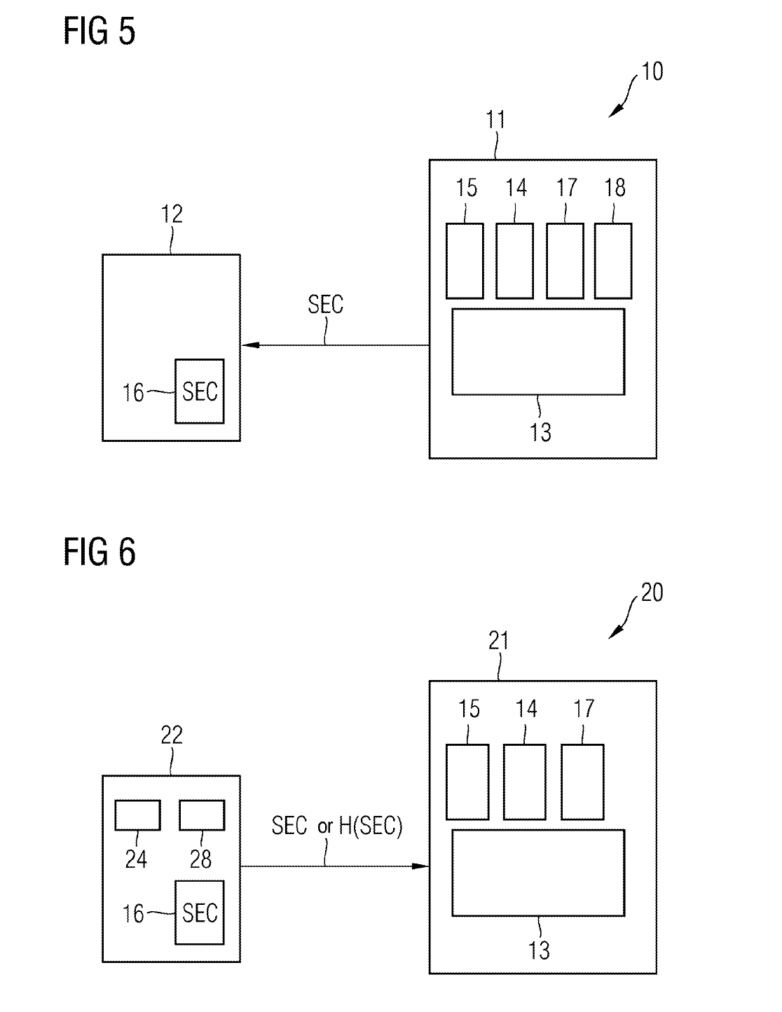

FIG. 6 shows a second exemplary embodiment of a system in a schematic representation.

Mutually corresponding parts are provided with the same reference symbols throughout the figures.

Security-relevant events, such as e.g. failed login attempts or a change of system-relevant parameters are typically recorded, for example by computation apparatuses, but also field devices in automation installations, and stored in each individual computation apparatus. Additionally, security-relevant events of this kind can also be transmitted to and stored on a central monitoring unit. Usually, these security-relevant events are initially stored only locally as data records, and access to these data records is protected by the operating system by means of specific role-based access rights. If a successful attack has been performed on a computation apparatus, the attacker can also obtain the necessary access rights and erase or alter these security-relevant data records. This allows the attack to be concealed afterwards.

### DETAILED DESCRIPTION

FIG. 1 now depicts an embodiment of the method according to the invention as a flowchart 30 that can be used to identify changes to the security-relevant data records afterwards too. In the initial state 31, a computation apparatus is available at an initialization time, for example at the time at which the computation apparatus is put into operation. In step 32, a secret is now assigned to the computation apparatus. The secret may have been generated in the computation apparatus itself, for example. Alternatively, the secret may have been generated in a security apparatus, which may be in the form of a standalone unit that is physically separate from the computation apparatus or alternatively may be available as a specially protected unit within the computation apparatus if both reading and subsequent overwriting of the secret stored in the security apparatus by the computation apparatus are not possible.

In method step 33, a first cryptographic key is now generated from the secret by means of a one-way function. This can be performed in the computation apparatus. Alternatively, if the secret has been generated in a security apparatus implemented separately from the computation apparatus, the first cryptographic key can be generated in the security apparatus using the same one-way function as is also used in the computation apparatus, based on the secret. In this case, the first cryptographic key is then transmitted to the computation apparatus. At the end of method step 33, the first cryptographic key is available in the computation apparatus.

In the next method step 34, it is ensured that the secret is not accessible in the computation apparatus and the secret is stored on a security apparatus, which is different than the computation apparatus. If the secret has been generated in the security apparatus, then it is merely stored therein. If the secret has been generated in the computation apparatus, then the secret needs to be transmitted to the security apparatus. Thereafter, the secret is then immediately erased or overwritten by the first cryptographic key, for example, in the computation apparatus.

Following this, in method step 35, the first cryptographic key is used to safeguard a first security-relevant data record. Subsequently, in method step 36, the next cryptographic key is now generated using the same one-way function on the basis of the preceding cryptographic key, that is to say in this case the first cryptographic key, and at the same time the preceding cryptographic key, in this case the first cryptographic key, is erased or, by way of example, overwritten by the new cryptographic key. To safeguard the next security-relevant data record, the next cryptographic key that is available in the computation apparatus is now used in method step 38.

Optionally, it is now possible to check in method step 39 whether a prescribed event, for example the overshooting of a counter that is increased whenever a cryptographic key is generated, has reached a maximum value. A further prescribed event may be, by way of example, the requesting of the security-relevant data records from the computation apparatus by a central component, for example. If such an event occurs, the method is continued in method step 32 by virtue of a new secret being assigned to the computation apparatus. The new secret is transmitted to the security apparatus. Following this, all further security-relevant data records are protected by using cryptographic keys based on this new secret. It is moreover ensured that the new secret is no longer accessible in the computation apparatus.

If such a event does not occur in method step 39, the method is continued in step 36 by generating a respective next cryptographic key using the same one-way function on the basis of the respective preceding cryptographic key, using said next cryptographic key to safeguard the next security-relevant data record in step 37 and subsequently erasing or overwriting said next cryptographic key. The final state 40 is reached when the computation apparatus is taken out of operation, for example.

The secret is subsequently accessible only in the security apparatus, and can later be used during a forensic analysis of the computation apparatus to generate all cryptographic keys used in the computation apparatus. These restored keys can therefore be used retrospectively to read the safeguarded security-relevant data records and to check the integrity thereof.

The one-way function used to generate the first and all subsequent cryptographic keys may typically be a hash function. In this case, the one-way function needs to have the property that it is not possible to infer the input parameter X from the knowledge of the value H(X) that results from the one-way function. Cryptographic hash functions typically have this property and are therefore suitable for use as a one-way function in the method described. The one-way functions used may be the methods SHA2, SHA3 and Whirlpool, for example. Other one-way methods, as are usually used for deriving cryptographic keys, can also be used, provided that all keys generated can be derived in a reproducible manner from the original secret.

In order to provide, in different computation apparatuses, different cryptographic keys that cannot be ascertained through the knowledge of the cryptographic keys of other apparatuses, the secret used to compute the first cryptographic key in the different computation apparatuses needs to be as independent as possible of the secrets in the other computation apparatuses. Therefore, such a secret is usually generated by using random numbers that are preferably based on actually random physical events. These are usually generated in a random number generator.

In order to reduce the demand on the quality of the random number generator and to increase the randomness of the secret, it is possible, as depicted in FIG. 2, for a secret SEC to have not only a random number RAND as a first component but also a second component ANS. In this case, the second component ANS may be an answer to a security question that an engineer needs to give when installing the computation apparatus, for example. It is possible to make spying out the secret SEC even more difficult by virtue of the second component ANS and the first component RAND of the secret SEC being stored at different physical locations, and the secret being recombined from both portions only when the safeguarded security-relevant data records are checked. In this case, it is necessary to ensure that it is possible to access this answer ANS to a security question when the safeguarded security-relevant data records are checked. E.g. it would be possible for the answer to the security question to be kept in a safe.

FIGS. 3 and 4 now depict the security-relevant data records LOG1, . . . , LOGn, . . . , LOGn that have accrued over a time t in safeguarded form. In this case, the respective cryptographic key used, and how this key has been generated, is indicated to the right beside the data records and their safeguard.

FIG. 3 shows the stored security-relevant data records LOG1, . . . , LOGn. For safeguarding purposes, a message authentication code HMAC (LOGn, Kn), for example, is stored for each security-relevant data record in this case, said message authentication code being obtained as an input parameter, for example in accordance with IETF standard RFC 2104 “HMAC: Keyed-Hashing for Message Authentication”, from the security-relevant data record LOGn and the respective associated cryptographic key Kn using a function. The first cryptographic key K1 is obtained from the one-way function applied to the secret. Accordingly, the message authentication code pertaining to the first data record is formed using the first data record and the first cryptographic key as input parameters. After the message authentication code has been generated, the second cryptographic key is then formed by now applying the one-way function to the first cryptographic key. Subsequently, the first cryptographic key is immediately erased or overwritten by the second cryptographic key. A similar procedure is used for all subsequent security-relevant data records. Thus, as depicted for the data records LOGn and LOGn+1, the cryptographic key Kn+1 is formed in each case from the preceding cryptographic key Kn by applying a one-way function H, for example a cryptographic hash function.

FIGS. 3 and 4 each depict the data actually available or stored in the computation apparatus in an outlined form. Therefore, besides the security-relevant data records LOG1, . . . , LOGp and the associated message authentication codes HMAC (LOG1, K1), . . . , HMAC (LOGp, Kp), only the cryptographic key Kp+1 to be used for the next data record is stored in the computation apparatus. All preceding cryptographic keys are no longer available.

The message authentication code now allows the stored security-relevant data records to be checked for their integrity. To this end, the secret stored in the security apparatus must again generate all cryptographic keys through iterative application of the one-way function to the secret or the respective cryptographic keys generated therefrom, and a message authentication code needs to be generated from the stored data record and the associated key. If the resulting message authentication code matches the stored message authentication code, then the data record has not been altered. If the two message authentication codes do not match, then the stored security-relevant data record differs from the originally existing data record. This indicates a manipulation.

In FIG. 4, the security-relevant data records have been safeguarded by virtue of the data record LOGn itself having been encrypted using the associated cryptographic key Kn and stored merely in encrypted form as E_Kn{LOGn}. A suitable encryption method is e.g. a symmetric encryption method such as 3DES, AES or IDEA.

FIGS. 5 and 6 now show two exemplary embodiments of a system according to the invention. The system 10 in FIG. 5 and the system 20 in FIG. 6 comprise a security apparatus 12, 22 and one or more computation apparatuses 11, 21. In this case, the computation apparatus 11 may be a field device or sensor device of an automation installation or of a power distribution installation, for example, or else an apparatus from medical engineering in which security-relevant data, for example patient data, are stored in protected form. The computation apparatus may also be a tachograph within a vehicle.

In this case, the system 10 supports generation of the secret in the computation apparatus 11 and is connected to the security apparatus 12, for example via a communication link, such as an installation communication network, for example. The computation apparatus 11 comprises a secret generation unit 18 that comprises a random number generator, for example, or receives a random number from a random number generator of the computation apparatus as a basis for forming the secret. The secret SEC is transmitted to the security apparatus 12 via the communication link. To this end, the security apparatus 12 comprises a secret memory 16 that is used to store the secret SEC.

Furthermore, the computation apparatus 11 comprises a key generation unit 14 that comprises a one-way function H that is used to generate the subsequent cryptographic key K1 or Kn from the secret SEC or a preceding cryptographic key Kn−1. The current key K1 or Kn generated is stored in a key memory unit 17. The secret SEC or the preceding key Kn−1 is overwritten by the subsequently formed key K1 or Kn.

A control unit 15 can have prescribed events or prescribed parameters stored in it. The control unit 15 is designed to check the present circumstances against the prescribed events before the next cryptographic key is generated and, if required, to initiate fresh secret generation in the computation apparatus 11.

The computation apparatus moreover comprises a security data memory unit 13 that stores the safeguarded security-relevant data records.

FIG. 6 shows a system 20 in which a security apparatus 22 generates the secret and makes it available to the computation apparatus 21 via a communication link. In this case, the commutation apparatus 21 comprises only the key generation unit 14 and also the key memory unit 17, a control unit 15 and a security data memory unit 13 that stores the safeguarded security-relevant data records.

In this case, the security apparatus 22 comprises a secret generation unit 28 in which the secret SEC is generated. Besides a random number RAND, there may also be a second portion ANS of a secret, for example an answer to a security question, stored therein that is used to form a new secret with the freshly formed random number when a new secret needs to be generated.

The security apparatus 22 furthermore comprises a key generation unit 24 in which a first cryptographic key K1 is generated from the secret SEC by means of a one-way function H. As in the security apparatus 12 of simpler design, the security apparatus 22 comprises a secret memory unit 16 for securely storing the secret SEC for a later check on the security-relevant data records. Similarly, a function for checking prescribed events that require renewed assignment of a secret is checked and performed in the control unit 15.

For a check on the computation apparatuses 11, 21, all subsequent cryptographic keys can be computed in a simple manner from the secret SEC. These keys can also be used to identify whether the security-relevant data records have been altered or erased. Erasure of security-relevant data can be detected by virtue of it being not the successive cryptographic keys that have been applied for safeguarding purposes between two successively stored data records, but rather a later cryptographic key. From this, it is possible to ascertain the number of erased data records. Since a time stamp is usually generated and stored with each stored data record, it is therefore also possible to establish the time from which the data structures have been manipulated. Hence, the cited method 30 and the cited system 10, 20 can also retrospectively identify whether security-relevant data records have been manipulated.

All the features described and/or drawn can be advantageously combined with one another within the context of the invention. The invention is not limited to the exemplary embodiments described.

1. A method for identifying manipulation of data records in a system comprising a computation apparatus and an external security apparatus, wherein the data records are stored in the computation apparatus, comprising the method steps of:
assigning a secret to a computation apparatus;
generating a first cryptographic key using a one-way function on a basis of the secret;
storing the secret on a security apparatus that is different than the computation apparatus;
using the first cryptographic key to safeguard a first data record, and ensuring that the secret is not accessible in the computation apparatus, and
generating a respective next cryptographic key using the same one-way function on a basis of the respective preceding cryptographic key in order to safeguard a next data record on the computation apparatus and simultaneously erasing or overwriting the respective preceding cryptographic key.

2. The method as claimed in claim 1, wherein the secret is generated in the computation apparatus and is transmitted to the security apparatus.

3. The method as claimed in claim 1, wherein the secret is generated in the security apparatus and is transmitted to the computation apparatuses.

4. The method as claimed in claim 1, wherein the secret and the first cryptographic key are generated on the security apparatus and only the first cryptographic key is subsequently transmitted to the computation apparatus.

5. The method as claimed in claim 1, wherein the safeguarding of the data record is performed by encrypting the data record using the cryptographic key.

6. The method as claimed in claim 1, wherein the safeguarding of the data record is performed by assigning a message authentication code generated using the cryptographic keys to the data record.

7. The method as claimed in claim 1, wherein the secret comprises an answer character string that has been provided as an answer to a security question.

8. The method as claimed in claim 1, wherein a new secret is assigned to the computation apparatus on the basis of a prescribed event, and the subsequent method steps of claim 1 are performed using the new secret.

9. The method as claimed in claim 1, wherein a new secret is assigned to the computation apparatus after a request for the data records, and the subsequent method steps of claim 1 are performed using the new secret.

10. A system for identifying manipulation of data records, comprising a computation apparatus and an external security apparatus that is remote from the computation apparatus, wherein the computation apparatus is configured to:
use a first cryptographic key that has been generated by a one-way function on a basis of a secret for a purpose of safeguarding the first data record, and to ensure that the secret is not accessible in the computation apparatus; and
generate a respective next cryptographic key using the same one-way function on a basis of the respective preceding cryptographic key for a purpose of safeguarding a next data record and to simultaneously erase or overwrite the respective preceding cryptographic key, and to store the safeguarded data records, and wherein the security apparatus is designed to store the secret.

11. The system as claimed in claim 10, wherein the computation apparatus is configured to generate the secret and to transmit the secret to the security apparatus.

12. The system as claimed in claim 10, wherein the security apparatus is configured to generate the secret and to transmit the secret to the computation apparatus.

13. The system as claimed in claim 12, wherein the security apparatus is configured to generate the secret and the first cryptographic key on the basis of the generated secret and subsequently to transmit the first cryptographic key to the computation apparatus.

14. The system as claimed in claim 10, wherein the computation apparatus is configured to perform the safeguarding of the data record by encrypting the data record using the cryptographic key or by assigning a message authentication code generated using the cryptographic key to the data record.

15. A computer program product having program commands for performing the method as claimed in claim 1.
